(19) United States
(12) Patent Application Publication
(10) Pub. No.: US 2017/0346377 A1
(43) Pub. Date: Nov. 30, 2017

(54) TANGENTIALLY ACTUATED ELECTRICAL GENERATOR

(71) Applicant: David Deak, SR., Head Of The Harbor, NY (US)

(72) Inventor: David Deak, SR., Head Of The Harbor, NY (US)

(21) Appl. No.: 15/602,167

(22) Filed: May 23, 2017

Related U.S. Application Data
(60) Provisional application No. 62/341,339, filed on May 25, 2016.

(51) Int. Cl. H02K 35/02; H02K 1/34; H02K 7/06; H02K 7/18

(52) U.S. Cl. CPC H02K 35/02; H02K 7/1853; H02K 1/34; H02K 7/06

(57) ABSTRACT

A novel method of triggering an electromagnetic type energy harvesting generator that has disposed a spherical magnet, surrounded by a coil of wire and rotatable in an enclosure about an axis with an axially protruding paddle member, axially aligned dual offset paddle members, or other flick trigger mechanism structure situated tangent along the surface of the spherical magnet enclosure, whereinthis enclosed magnet is centred within the electrical coil, which is free to rotate about its axis. The magnet is held in a static state rotational position by two opposite outwardly disposed flux focus magnets. The spherical magnet and the focus magnets are all in a magnetic attractive circuit; and the magnetic flux lines are in a static field concentration throughout the coil windings aided by the focus magnets. A reciprocating trigger device means with a contact finger is utilized to engage the axially protruding paddle member(s).

### FIELD OF THE INVENTION

The present invention relates to energy harvesting electrical generators, in particularly single-motion or impulse actuated electrical generators.

### BACKGROUND

Energy harvesting devices cover a wide range of power generation, especially generating electrical energy from mechanical motion, and have size versus efficiency choices that are significantly limited and in general, inadequate. Further efforts by others related to continuous or short burst types have not shown significant improvements and do not show any greater problem or application understanding likely to provide any significant improvements thereof.

### SUMMARY

The present invention provides and teaches that a variable speed range of motion triggering can be supplied by an external push force on a plunger embodiment causing the Faraday effect of inducing a voltage to occur at the coil terminals in a continuous or pulsed periodic rotational energy harvesting generator. Whether the plunging movement progression is slow action or fast action once the plunger moves the spherical magnet (responsible for power generation) past the trigger release point of a perpendicular tooth situated on the side of the spherical magnet adjacent to its common axels, the combined response of the power generating magnet in conjunction of the focusing magnets surrounding the coil creates a distorted and changing magnetic field surrounding and cutting the coil windings, a varying power envelope is produced.

The overall Faraday effect of inducing a voltage at the generator coil terminals is further enhanced by utilizing a plurality of focusing magnets to concentrate the magnetic field throughout the generator coil windings; and with every movement of a plunger in momentary and periodic mechanical connexion to a centrally located rotatable magnet of a spherical shape, but not limited to a spherical shape within the coil, a voltage is produced at the coil terminals due to the Faraday effect of induced voltage through magnetic field changes. With this arrangement a damped sinusoidal alternating current is established at the coil terminals.

The EMF (Electro-Motive Force, a.k.a. voltage) generated by Faraday's law of induction (the flow of current through a coil around a electrical complete circuit due to relative movement or change of a coil magnetic field) is the phenomenon underlying electrical generators; however, most texts covering the Faraday Principle illustrates a moving coil through a stationary magnetic field source (a magnet), with the present invention the converse holds true where a magnet is moved rotated through a stationary electric coil. When a permanent magnet is moved relative to a conductor, or vice versa, an electromotive force (voltage) is created. If the wire is connected through an electrical load, current will flow, and thus electrical energy is generated, converting the mechanical energy of motion to electrical energy, thus ‘harvesting’ mechanical energy as electrical energy for some usage.

The present invention's exemplary embodiments include utilizing rare-earth or high field strength magnets such as Neodymium magnets but are not limited using conventional Neodymium magnets. There also exists a novel category of Neodymium magnets that are identified as ‘poly-magnets’. Poly-magnets start as regular rare earth magnets. However, poly-magnets are entirely different from conventional magnets, which have one north and one south pole. Poly-magnets contain patterns of North and South poles, such as alternating north and south pole ‘lines’, on a single piece of magnetic material. The fields coming off of these patterns of north and south poles in turn define the feel and function of the poly-magnet. The field on the poly-magnet is tightly focused because the fields don't have to go as far to connect from north to south. The same amount of energy is present in both magnets, but the poly-magnet has much more energy focused in front of the magnet where it can do work.

### BRIEF DESCRIPTION OF THE DRAWINGS

These and further features of the present invention will be better understood by reading the Detailed Description, taken together with the Drawing figures, wherein:

FIG. 1A an isometric view of a coil assembly disposed within a magnet bed assembly with six focus magnets surrounding a spherical magnet with a radially extending trigger member according to one embodiment of the present invention;

FIG. 1B a plan (top) view of the embodiment of FIG. 1A;

FIG. 1C an elevation (side) view of the embodiment of FIG. 1A:

FIG. 2A is an elevation (side) view of plunger tangentially moving relative to a radially extending trigger member of a further embodiment of the present invention;

FIG. 2B is an elevation (side) view of the embodiment of FIG. 2A with the tangential plunger offset to the left having left engagement with the radially extending trigger member and corresponding magnetic field distortion;

FIG. 2C is an elevation (side) view of the embodiment of FIG. 2A with the tangential plunger pushing past the right side of the radially extending trigger member causing the attached the spherical magnet to oscillate forth and back, and corresponding magnetic field distortion;

FIG. 3A is an elevation (side) view of the tangential plunger, going from right to left, and the .plot of voltage over time induced in response to the spherical magnet in a quiescent (resting) position for the embodiment of FIG. 2A;

FIG. 3B is an elevation side view of the tangential plunger as its movement is imparted to the radially extending trigger member, and the a plot of voltage induced in a surrounding coil in response to changes in the stationary magnetic field by rotation of the spherical magnet shown in FIG. 2A;

FIG. 3C is an elevation (side) view of a tangential plunger, illustrating its trigger movement positioned to the right well beyond the radially extending trigger member and a plot of voltage over time from a coil surrounding the spherical magnet which freely rotates back and forth over several cycles;

FIG. 4A is an elevation (side) view of the coil, bobbin, winding (in cross-section), and spherical magnet assembly disposed within the centre of the coil surrounded by representative magnet among multiple-magnets;

FIG. 4B is a plan (top) view of the embodiment of FIG. 4A;

FIG. 5A is an elevation (side) view of a further embodiment with a plunger and rotatable magnet in a rest position, and a typical zero output waveform induced in a coil winding surrounding the magnet;

FIG. 5B is an elevation (side) view of the embodiment of FIG. 5A, with the plunger causing the spherical magnet to move to the left, and a corresponding non-zero output waveform of a low amplitude voltage waveform induced in the surrounding coil for the period of magnet movement;

FIG. 5C is an elevation (side) view of the embodiment of FIG. 5A, with the plunger's trigger moved to a position well beyond the contact point with the magnet trigger;

FIG. 5D is an elevation (side) view of the embodiment of FIG. 5A, with a plunger farther away from the magnet trigger and the rotatable magnet in a position of magnetic force equilibrium, and a corresponding non-zero output waveform of a low amplitude voltage waveform induced in the surrounding coil for the period of magnet movement;

FIG. 6A is an elevation (side) view of a further embodiment of the generator according to the present invention with a plunger in a rest position with non-contacting Poly-magnet trigger mechanism, and a typical output waveform during no movement rest time;

FIG. 6B is an elevation (side) view of the embodiment of FIG. 6A with the plunger pushed into action and corresponding movement of the spherical magnet housing to the left, and including a typical non-zero output waveform of a low amplitude voltage waveform resulting from the plunger movement;

FIG. 6C is an elevation (side) view of the generator embodiment of FIG. 6A with a plunger returned to the rest position, and showing a typical non-zero output waveform of a low amplitude voltage waveform up to some time period of movement;

FIG. 7A is a perspective view of a typical neodymium magnet with a bi-polar configuration of a North Pole volume and a South Pole volume, each having a corresponding external surface;

FIG. 7B is a perspective view of a poly-magnet that has a plurality of North and South Pole sub-volumes and sub-surfaces;

FIG. 8 is a schematic illustration of a further embodiment according to the present invention including a key actuator received into the energy harvesting generator;

FIG. 9A is a schematic illustration of further embodiment according to the present invention providing a staggered multi-trigger plunger in a rest position;

FIG. 9B is a schematic illustration of the embodiment of FIG. 9A in an initial pushed position striking and moving a first tooth and the resulting displacement of the rotatable magnet; and

FIG. 9C is a schematic illustration of the embodiment of FIG. 9A in return position after displacement

FIG. 10 is a perspective view of a partial cut-away of a further embodiment of the present invention; and

FIGS. 11A-11D are elevation views of the embodiment of FIG. 10 showing stages of progressive trigger (actuator) depression.

### DETAILED DESCRIPTION

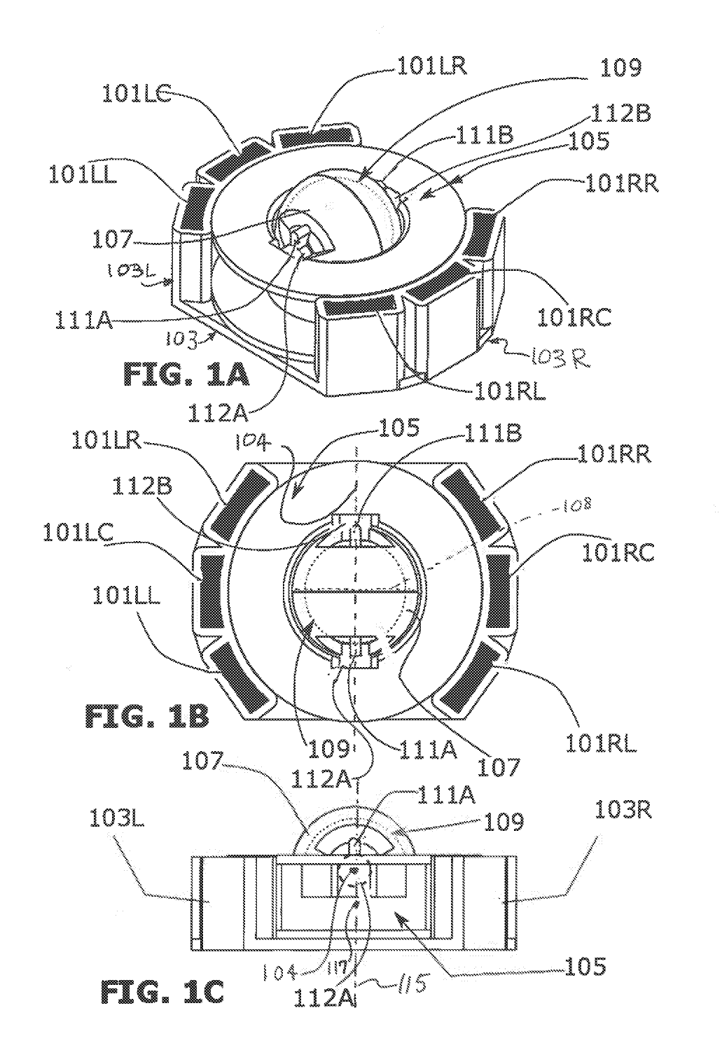

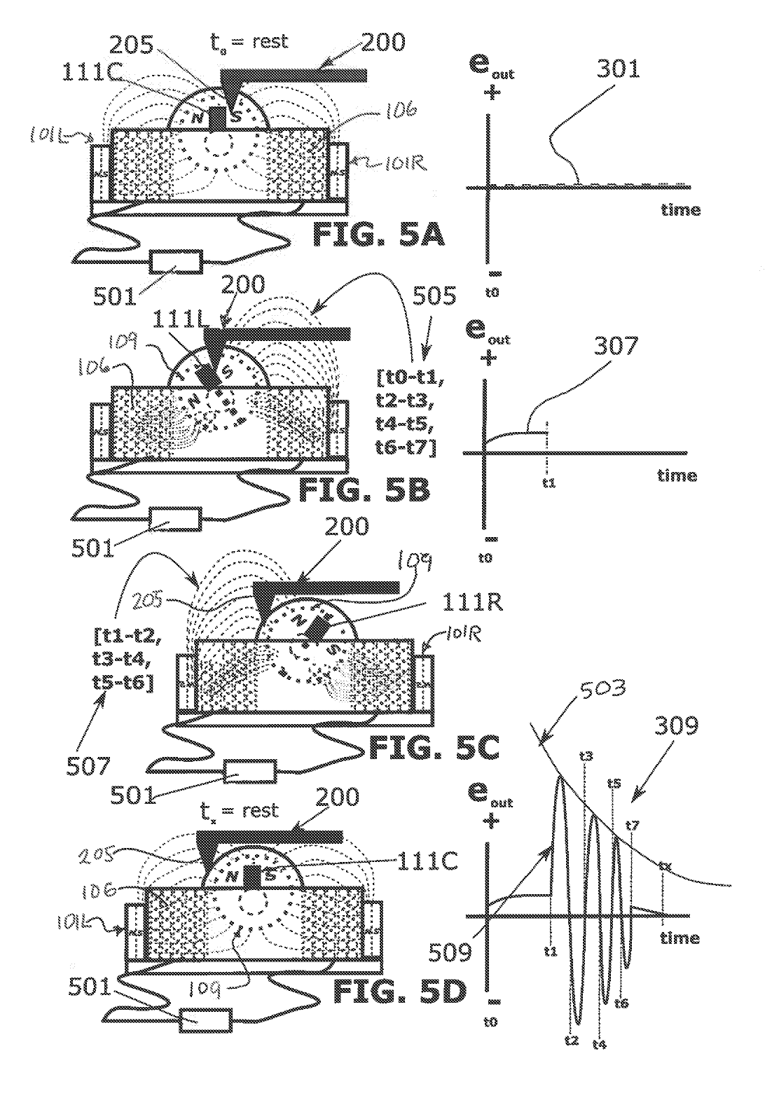

Consider the perspective view in FIG. 1A showing a coil assembly disposed within a magnet bed assembly with six focus magnet and the coil bobbin including a spherical magnet encapsulated within a non-magnetic cover with trigger teeth, also shown in the top plan view in FIG. 1B, and the side elevation view in FIG. 1C for an arrangement of a coil bobbin 105 having a longitudinal axis 115 with a winding of many turns of copper wire (106, FIG. 5A) that has a through hole at its centre surrounding said longitudinal axs 115 that accepts a spherical magnet 109 that is encapsulated within a non-magnetic cover 107 with common axels 111A, 111B and above each common axel member there exists a tooth protrusion member 111A & 111B on each side of the magnet axels 112A & 112B; and is part of the encapsulated cover 107. Alternate embodiments include axels otherwise formed and attached to or through the spherical magnet 109 and/or cover 107. Further this non-magnetic encapsulation is designed and constructed such that the magnetic imaginary equator at 108 that defines and separates the magnetic poles North and South, is aligned so that the imaginary equator is parallel to the vertical side of each tooth protrusion member 111A & 111B. With this embodiment of the invention the coil bobbin 105 and included wire coil is disposed within and surrounded by a magnet bed 103L, 103R having a plurality of focus magnets typically residing in slots, and the spherical magnet 109 that is encapsulated within the non-magnetic cover 107 is disposed in the centre through hole of the coil bobbin 105. In the embodiment of FIG. 1A, there exists a plurality of focus disk magnets (not shown) that are disposed (within vertical slots)at position left side left position 101LL, position left side centre position 101LC, left side right position 101LR, right side left position 101RL, right side centre position 101RC, and right side right position 101RR, which are attached members of the magnet bed 103 on each of its sides 103L and 103R to closely surround (or contact) the coil bobbin 104 (or wire coil 106, below) as shown. In addition, the spherical magnet 109 encapsulated within its cover 107 along with its axels 112A and 112B are aligned and positioned along a magnet axis 104 within the coil bobbin 105 centre hole and preferably more proximal to, or at the edge of the coil bobbin 105 (other disposition may also be provided) and in this embodiment, offset from and parallel to a coil axis of symmetry 117, FIG. 1C; and free to rotate such that the North and South poles of the magnet are capable of being rotated, by some externally applied force, and being able to move to the left and to the right of centre (e.g. when tooth 112A, 112B is substantially near the midpoint of its rotational travel) when a force action is administered to the spherical magnet 109 within its cover 107.

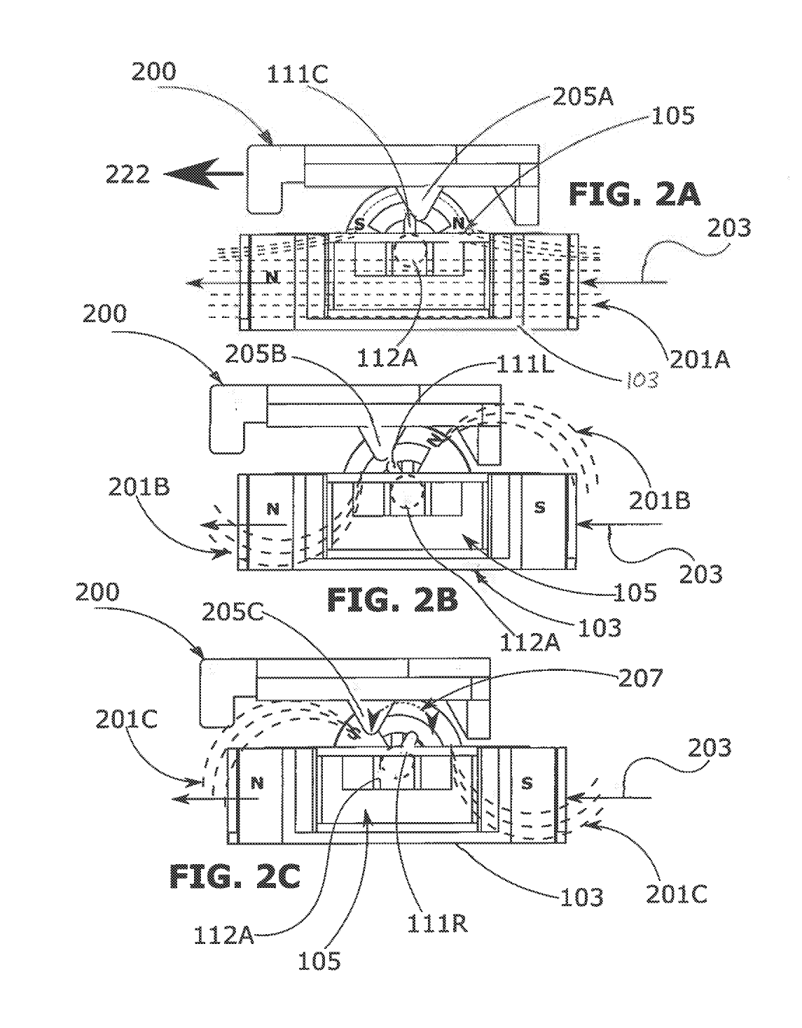

FIG. 2A shows a side view of an embodiment of the present invention that illustrates a movement of a plunger 200 moving in a leftward direction 222 to return to a quiescent position after having been previously moved to the right, and the plunger's trigger mechanism 205 protruding member at position 205A of the plunger 200 momentarily comes in contact with a vertical tooth 111, part of the spherical ball magnet assembly 107 that contains a ball magnet 109, is in its centre rest position 111C. At this moment in time the encompassed magnet field 201A established by the presence of the ball magnet 109 and six focus magnets residing in the slots shown in FIG. 1 formed in the bed 103, which consequently has the magnetic poles aligned 203 in a magnetic attractive-pole field circuit 201A (i.e. facing ball magnet and focus magnet poles being opposite polarity) between the ball magnet 109 and the six focus magnets (residing in corresponding bed 103 slots) 101LL, 101LC, 101LR, 101RL, 101RC, 101RR contained in the magnet bed 103L, 103R.

In FIG. 2B this side view illustrates the movement progressive action position of a plunger that has its trigger mechanism 205-member position 205B (subsequent to

FIG. 2A) moved to the extreme left limit position and this progressive action allows for the spherical magnet 109 and its encapsulated cover 107 along with the attached tooth member 111, all to move to the extreme left limit position 111L and causes the resultant force to stretch and distort the encompassed magnetic field 201B such that the field 201B moves throughout the coil winding; and whenever there is a change in the magnetic field through a coil on bobbin 105, there is a voltage polarity established across the terminals (winding ends) of the coil on the bobbin 105 according to Faraday's Law of electromagnetic induction.

Now with FIG. 2C, the side view illustrates the movement 222 progressive action position of a plunger subsequent to that shown in FIG. 2B, that has its trigger mechanism 205-member position 205B moved to the extreme left limit position and allows for the spherical magnet 109 having N and S poles disposed as provided above, and its encapsulated cover 107 along with the attached tooth member 111, all to be released and move to the extreme right limit position 111L and causes the resultant force to stretch and distort the encompassed magnetic field 201C such that the field 201C moves differently from that of FIG, 2B throughout the coil winding. Accordingly, whenever there is a change in the magnetic field through a coil on bobbin 105, there is a voltage of opposite polarity that was established across the terminals of a coil on the bobbin 105 as in referenced FIG. 2B according to Faraday's Law of electromagnetic induction. This oscillating action of the magnet 109 within the cover 107 shown in FIG. 2A, FIG. 2B, and FIG. 2C continue until converted into electrical energy in the coil (typically a damped sinusoidal wave), and friction between the spherical magnet 109 and its encapsulated cover 107 and the spherical magnet's axel members 112A and 112B shown in FIG. 1B, left member shown 112A in FIG. 2A, FIG. 2B, and FIG. 2C, overcome the original applied force of action pushing or from the plunger spring return (not shown) to an initial resting or quiescent position.

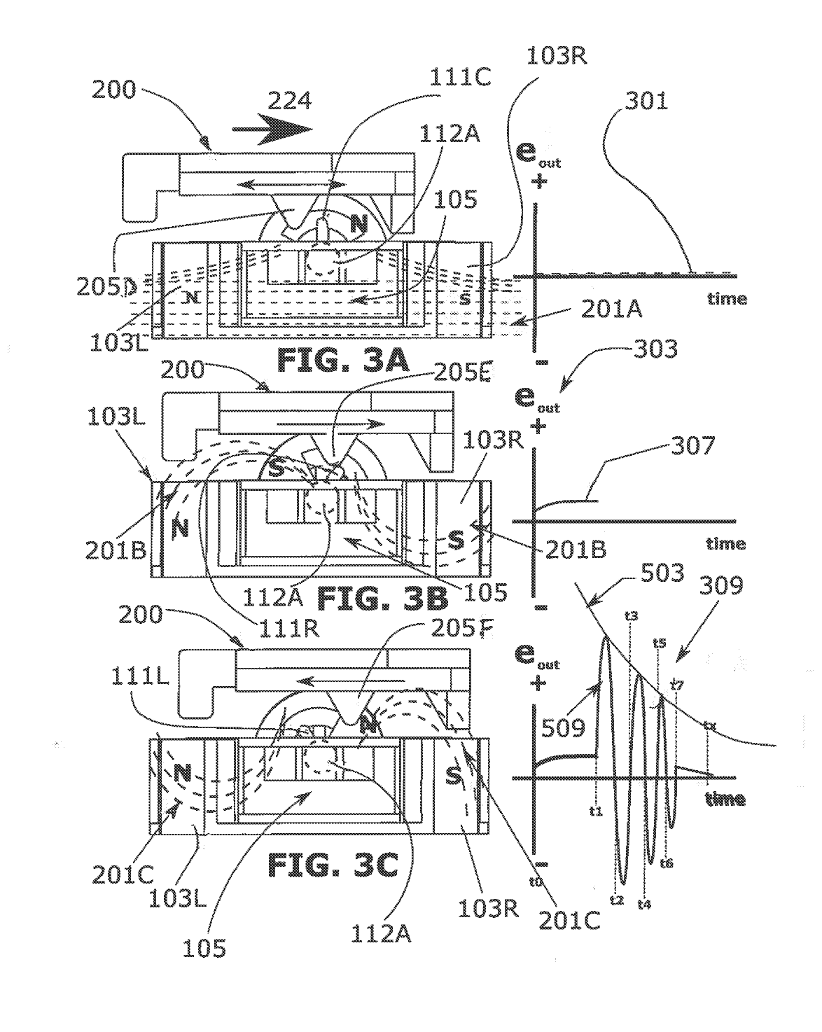

FIG. 3A shows a side view of an embodiment of the present invention that illustrates a movement of a plunger 200 moving in a rightward direction 224 and the plunger's trigger mechanism 205 position 205D momentarily comes in contact with a vertical tooth 111-member in its centre rest (quiescent, or magnetically balanced) position 111C, and is part of the spherical ball magnet assembly 107 that contains a ball magnet 109. At this moment in time the encompassed magnet field 201A established by the presence of the ball magnet 109 and six focus magnets retained as described in regard to FIG. 1, which consequently has the magnetic poles aligned 203 in a magnetic attractive-pole field circuit 201A (i.e. opposite confronting magnetic poles) between the ball magnet 109 and the six focus magnets 101LL, 101LC, 101LR, 101RL, 101RC, 101RR in corresponding slots contained in the magnet bed 103L, 103R, described above. A corresponding bobbin coil output voltage versus time is shows substantially no induced voltage in this resting period of the ball magnet 109.

In FIG. 3B this side view illustrates the movement progressive action position of a plunger 200 that has its trigger mechanism 205 in position 205E moved toward the extreme right limit position which allows for the spherical magnet 109 and its encapsulated cover 107 along with the attached tooth member in position 111L, all to move to its extreme right limit position and causes the resultant force to stretch and distort the encompassed magnetic field 201B such that the field moves throughout the coil winding contained on bobbin 105; and whenever there is a change in the magnetic field through a coil 105, there is a corresponding change of voltage and polarity established across the terminals of a coil on bobbin 105. As the relative motion of the magnet 109 is gradual with respect to the coil winding in the bobbin 105, a corresponding coil output voltage 307 Is shown in a plot of coil output voltage versus time, similar but of opposite polarity to what is produced by the motion describe and shown relative to FIG. 2B.

The side elevation of FIG. 3C illustrates a further rightward position in the movement of a plunger 200 that has its trigger mechanism 205 in position 205F moved to the extreme left limit position due to magnetic ‘a spring back’ action of secondary harmonic motion, allows for the spherical magnet 109 and its encapsulated cover 107 along with the attached tooth member 111, all to move to the extreme left limit position 111L and causes the resultant magnetic force to stretch and distort the encompassed magnetic field 201C such that the field moves throughout the coil winding and correspondingly whenever there is a change in the magnetic field through a coil of bobbin 105, there is a voltage of opposite polarity that was established across the terminals of a coil of bobbin 105 as above, in referenced FIG. 3B. The mass of the magnet 109 and cover 107 together with the force of magnetic spring-like attraction between the magnet 109 and surrounding focus magnets produces an oscillating action shown in FIG. 3C (and corresponding plot of coil output voltage versus time) that continues until the mechanical energy is converted to electrical energy, and friction between the spherical magnet 109 and encapsulated cover 107, and the spherical magnet's axel members 112A and 112B shown in FIG. 1B, left member shown 112A in FIG. 3A, FIG. 3B, and FIG. 3C, dissipates the energy imparted by the original applied force of action pushing.

For the initial action in FIG. 3A where the plunger 200 is in process of moving into a future position of striking and making its trigger mechanism 205D hit and push the spherical magnet assembly's tooth set member at centre position 111C there is not any voltage generated (301) at the coil output terminals (not Shown). For progressive action after the time of initial push as illustrated in FIG. 3A, FIG. 3B shows a moment in time where the plunger 200 trigger member 205E strikes and pushes forward the spherical magnet assembly's tooth member moved right 111R that causes the spherical magnet 109 to rotate clockwise and stretch and distort the resultant magnetic field at a rate that initially generates a low voltage level, if the push is slow action. Further progression of plunger movement, shown in FIG. 3C, causes the trigger mechanism 205F to push the tooth far enough so that the tooth disconnects contact with the trigger mechanism and the spherical magnet 109 and the tooth 111 is free to swing back and forth continuous time sequence 111L-111C-111R to 111R-111C-111L for a few cycles; and this action generates a strong voltage felt at the coil terminals (not shown) and that voltage waveform is a sinewave that is damped by a natural logarithmic descending curvilinear 503 set of values in time. These sinewave values during the illustrated time periods t1-t2, t2-t3, t3-t4, t4-45, t5-t6, t6-t7, and t7-tx diminish to zero when the spherical magnet assembly 107, 109, 111 ceases to rotate any further that is overcome by friction. Thus in the particular exemplary embodiment shown, the tangential plunger 200, illustrating its trigger movement positioned well beyond the spherical magnet's side tooth 111L in FIG. 3C, by either slow or fast movement by an external force, and allows the spherical magnet 109 to freely rotate back and forth over several cycles of a specifically defined angular displacement that in one embodiment, is typically in a range of plus 22.5 degrees from centre and minus 22.5 degrees of centre for an absolute value of 45.0 degrees for this embodiment. The spherical magnet 109 angular displacement can also be less than 45 degrees or more than 45 degrees, if so desired by design. As the spherical magnet oscillates or swings back and forth on its common axels 112L, 112R, the magnetic field 201A is stretched and compressed periodically in opposite directions back and forth in unison with the spherical magnet's movement. During this time of variable displacement activity, a damped sinewave, shown in FIG. 3C, is established at the terminal of the coil in accordance with Faraday's Law and Maxwell's Law.

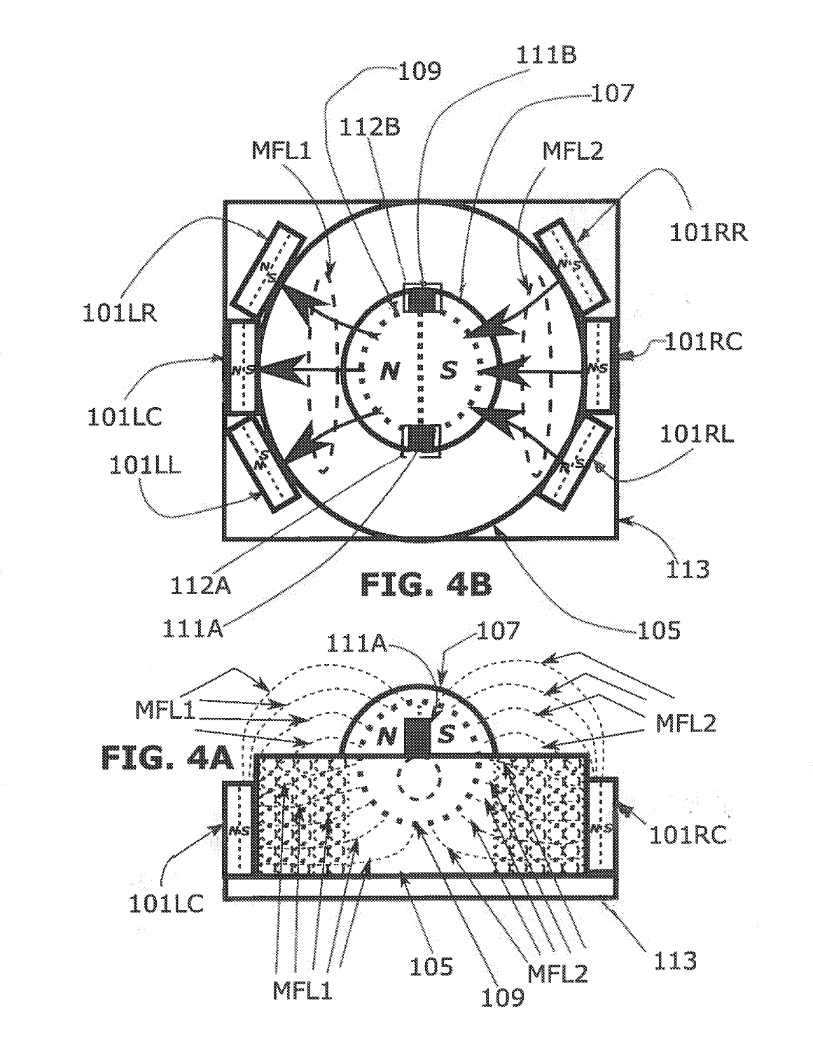

FIG. 4A shows a side view of a coil bobbin 105 with a disposed spherical magnet 109 enclosed in a non-magnetic jacket cover 107 with a dual tooth mechanism 111A and 111B (shown in the top view FIG. 4B). The spherical (ball) magnet 109 has its magnet poles situated with the North Pole and South Pole on substantially opposite left and right peripheral, outer edge or radial sides respectfully arranged in the present exemplary illustration. On each side of the coil bobbin winding exists at least one focus magnet 101LC on the left side and can have a plurality of adjacent magnets 101LL & 101LR in addition; and on the right side at least one focus magnet 101RC and can have a plurality of adjacent magnets 101RL & 101RR in addition. The exemplary planar magnet bed 113 holds around the coil bobbin 113, the plurality of focus magnets that can be comprised of disk shapes but not limited to disk shapes. Disposed on the spherical magnet jacket enclosure 107 are two axels 111A & 111B that hold in position the enclosed ball magnet 109 and allows for rotational movement within the coil bobbin winding. Because of this arrangement of ball magnet and associated focus magnets, there exists a circuitous surrounding magnet field shown in FIG. 4B that is a resultant of the individual focus and ball magnets. This circuitous resulting magnetic field MFL1 & MFL2 encompasses the coil windings and permeates throughout the windings. Whenever the ball magnet is moved the circuitous magnetic field is stretched and distorted throughout the windings and whenever the magnetic lines of force comprising the magnetic field is moved, in accordance to Faraday's Law, a voltage is produced at the coil winding terminals.

FIG. 5A illustrates a coil 106 retained by a bobbin or formed or molded to be self-supporting, with a ball magnet assembly 107 & 109 and a simple plunger 200 that tangentially moves the attached tooth (in quiescent or rest position 111C) radially extending from an axial shaft of the ball magnet assembly 107 & 109 rotationally to the left or right upon the plunger 200 movement action striking and engaging the vertical tooth 111 away from its centre 111C (and then by release of the plunger 200 trigger 205 after the trigger 205 travels past the tooth 111), the ball magnet assembly 107 & 109, engaging the magnetic fields of representative focus magnets 101L and 101R as described herein for other embodiments, swings left position 111L (FIG. 5B) and then to the right position 111R (FIG. 5C) in a continuous oscillating movement until the applied mechanical energy is converted and friction overcomes the energy supplied by the plunger 200 being pushed by an operator or connected apparatus (not shown).

The left side view of a slow action fast action generator embodiment is shown in FIG. 5B with the plunger 200 pushed into action and causing the spherical magnet and housing to rotate to the left, and the resulting typical non-zero coil 106 output waveform of a low amplitude voltage waveform 301 up to some time period of movement. The surrounding magnetic field 505 emanates throughout the coil winding 106 and the field 505 lines moves into a distortion pattern (relative to that shown in FIG. 5A) due to the caused movement, and occur at the indicated time intervals during the oscillatory motion of the movable magnet 109.

A left side view of a slow action generator embodiment of FIG. 5C with a plunger pushed and continued to be moved (beyond that of FIG. 5B) to a point where the plunger's trigger 205 is moved to a position well beyond the contact point with the spherical magnet's tooth at position 111R that allows for the spherical magnet 109 to oscillate back and forth as illustrated in FIG. 5D, by the corresponding waveform 509 that provides damped 309 waveform voltage decaying to zero, as the coil 106 voltage output from the generator during the oscillating time period. The surrounding magnetic field 507 emanates throughout the coil winding 106 and the field lines moves into a maximum distortion pattern due to that movement and the magnetic field pattern undulates and changes direction and polarity throughout the coil winding to induce a voltage in the coil with changing polarity in unison with the damped oscillating spherical magnet's back and forth movement, and occur at the indicated time intervals during the oscillatory motion of the movable magnet 109.

The left side view of a generator embodiment with a plunger after being pushed and moved to a point where the plunger's trigger is moved to a position well beyond the contact point with the spherical magnet's tooth that allows for the spherical magnet to oscillate back and forth for a few cycles as a result of magnetic engagement of opposite poled focus magnets 101L, 101R where the waveform of the coil 106 output voltage to zero is shown in FIG. 5D, plus the sinewave voltage output from the coil 106 of the generator during the oscillating time period. The surrounding magnetic field emanates throughout the coil winding and the field lines typically initially moves into a maximum distortion pattern (similar to 505, 507) due to that movement and the magnetic field pattern undulates and changes direction and polarity throughout the coil winding to induce a voltage in the coil 106 with changing polarity in unison with the damped oscillating spherical magnet's back and forth movement. Also the coil 106 exemplary output voltage waveform 509 over time (beginning at t1, then t2, t3, t4, t5, t6, and t7)is shown showing the damping 309 mechanism as it rings down from a maximum swing to a minimum and eventually to a non-motion rest equilibrium low energy state.

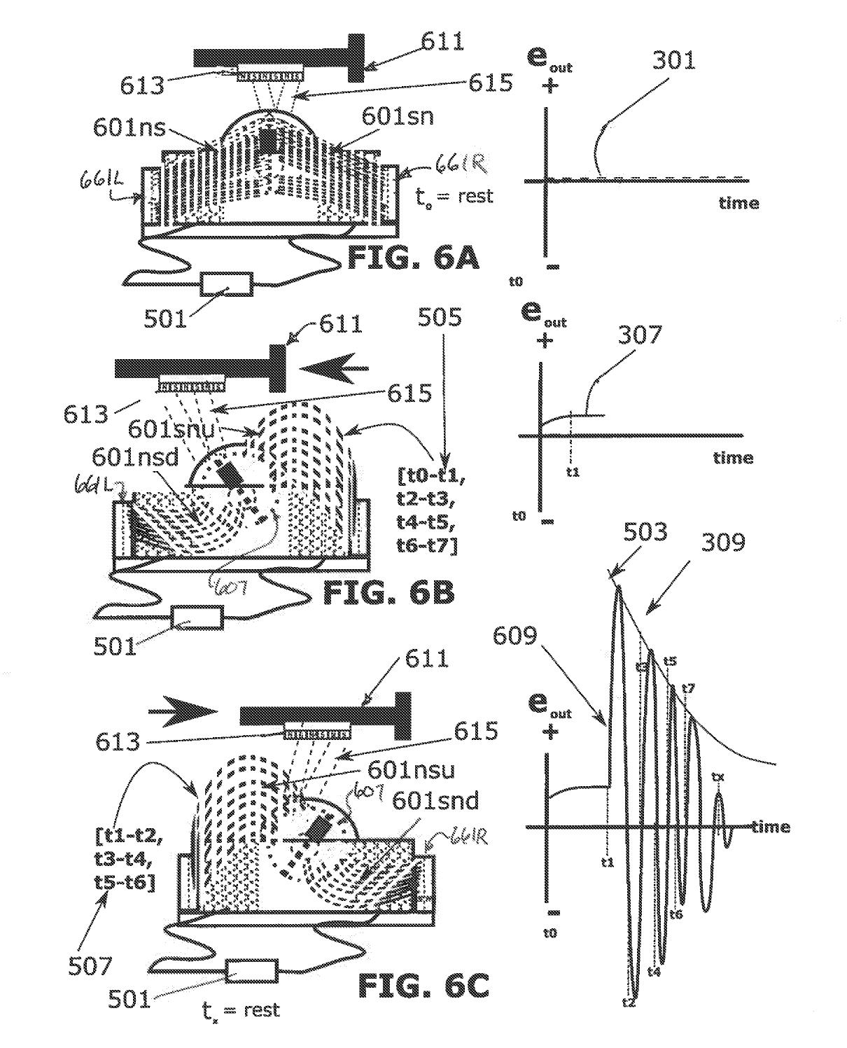

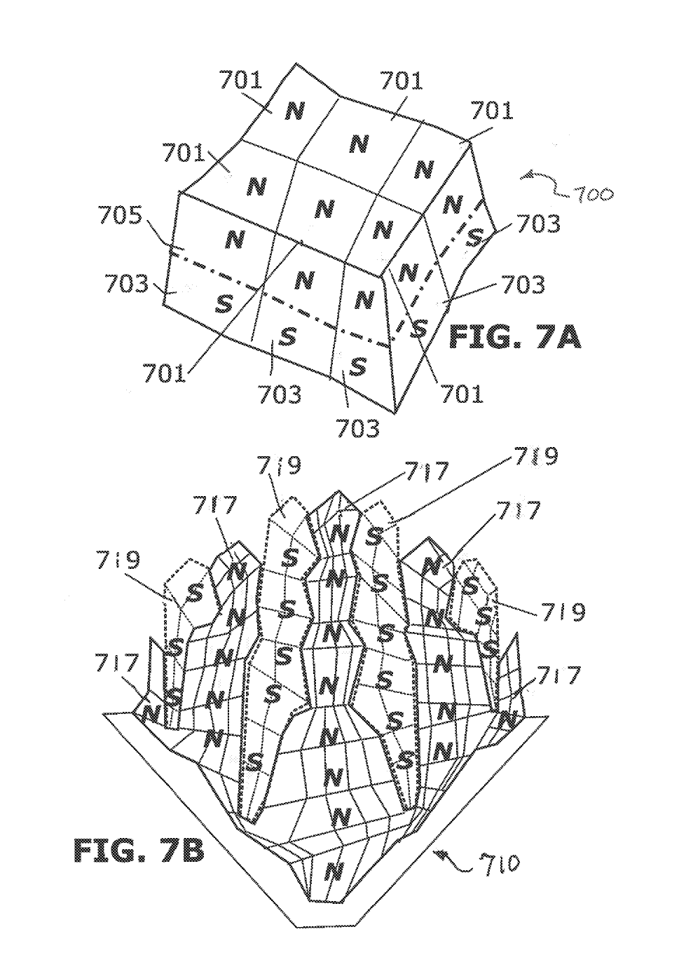

FIG. 6A is a left side elevation view of a generator embodiment with a plunger 611 in a rest position having a concentrated and specially designed set of focus magnets 661L, 661R having alternating poles (over the thickness of the coil 607 thereon as illustrated as a vertical distance in FIG. 7B), and to provide as a non-contact Poly-magnet trigger mechanism 613 to magnetically engage and rotate the magnet 607, which may also be a Poly-magnet as described herein, with alternating peripheral poles. plus a typical substantially zero output waveform 301A from the surrounding coil 106 during the initial (no movement) rest time.

FIG. 6B is a left side elevation view of the embodiment of FIG. 6A with a plunger pushed into action and causing the spherical magnet 607 housing to rotate to the left plus a typical non-zero output waveform 307A of a low amplitude voltage waveform for a time period of movement while the magnet 607 and the trigger 613 are still magnetically engaged. The surrounding magnetic field emanates throughout the coil winding 606 and the field lines 601snu, 601nsd moves into a distortion pattern due to that movement of the spherical magnet 607.

FIG. 6C is a left side elevation view of the embodiment of FIG. 6A, wherein the non-contact proximity Poly-magnet trigger mechanism 613, is displace to the right of the resting position shown in FIG. 6A while maintaining magnetic coupling to the rotating magnet 613 until time t1, providing a typical non-zero output waveform 309A of a low amplitude voltage waveform corresponding to the slow movement of the trigger 613. When the motion of the plunger 611 and trigger 613 are moved to exceed a distance that magnetic coupling with the rotating magnet 607 can be maintained, the rotating magnet 607 rotationally oscillates on its axis supports and generates a sinusoidal waveform 609 typically decaying 503A over time periods t2, t3, t4, t5, t6, t7, etc as the rotating (oscillating) magnet mechanical energy is converted to electrical energy applied to the load 501 and to normal friction losses. The surrounding magnetic field emanates throughout the coil winding and the field lines 601nsu, 601snd moves into a distortion pattern due to the trigger movement that pushed the spherical rotatable magnet and then further moved the spherical rotatable magnet to a point (t1) where the plunger's trigger is moved to a rightward position well beyond and breaking engagement with the spherical magnet's ‘tooth’ that allows for the spherical magnet to oscillate back and forth and the magnetic field pattern undulates and changes direction and polarity throughout the coil winding to induce a voltage in the coil with changing polarity in unison with the damped oscillating spherical magnet's back and forth movement. A similar effect is produced when in regard to FIG. 6B, the trigger 613 is moved sufficiently leftward to break engagement with the rotating magnet 607, releasing the rotating magnet to oscillate and generate a sinusoidal electrical energy similar to the waveforms 309A of FIG. 6C.

A typical neodymium magnet 700 with a bi-polar configuration of a North Pole 701 volume and a South Pole 703 volume separated at a substantially uniform boundary 705 is shown in the perspective view of FIG. 7A. Each magnetic pole occupies substantially all of a surface except for a surface having the boundary 705 therein.

A perspective view of a poly-magnet 710 is shown in FIG. 7B and has a plurality of North 717 and South Pole 719 sub-volumes and unlike a typical magnet of FIG. 7A where the magnet comprises only a single North and a single South Pole, the Poly-magnet has a plurality of alternating regions of North and South Poles, including a single surface that may have a plurality of alternating magnetic poles. In the exemplary embodiment show, the magnetic pole regions 717, 719 are elongated and/or layered; however, alternate dispositions of magnetic poles are possible and included in the scope of the present invention.

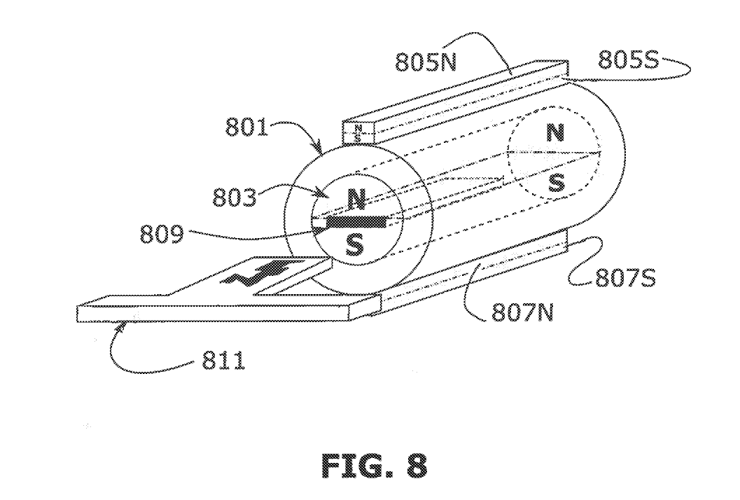

Another embodiment is shown in FIG. 8, which is a simplified schematic illustration of a key motion energy harvesting generator embodiment including an associated encompassed coil 801 in the resultant magnetic field of a central magnet 803 disposed within the coil 801 and a group of focus magnets each having their respective North pole (805N, 807N) and South pole (86S, 807S) disposed as taught above, forming an attraction field with the North and South poles of the central magnet 803 when in its quiescent state with its magnetic poles substantially aligned with the poles of the focus magnets. A key 811 is dimensioned to be received into a port 809 of the central magnet 803 or a part connected thereto to receive a turning force applied from the key by a user or attached mechanism. Upon rotation of the key 811 and the central magnet 803, the magnetic field between the magnetic poles of the central magnet 803 and the focus magnets will changes, e.g. as shown with regard to the above embodiments, and the coil 801 will experience a significant change in magnetic flux thereacross and therethrough. The magnetic coil 803 is wound in accordance with the teaching of the present invention and to experience a change in magnetic flux as provided by the relative rotation of the central magnet 803 relative to the focus magnets. Moreover, alternate embodiments may include additional focus magnets according to the present invention.

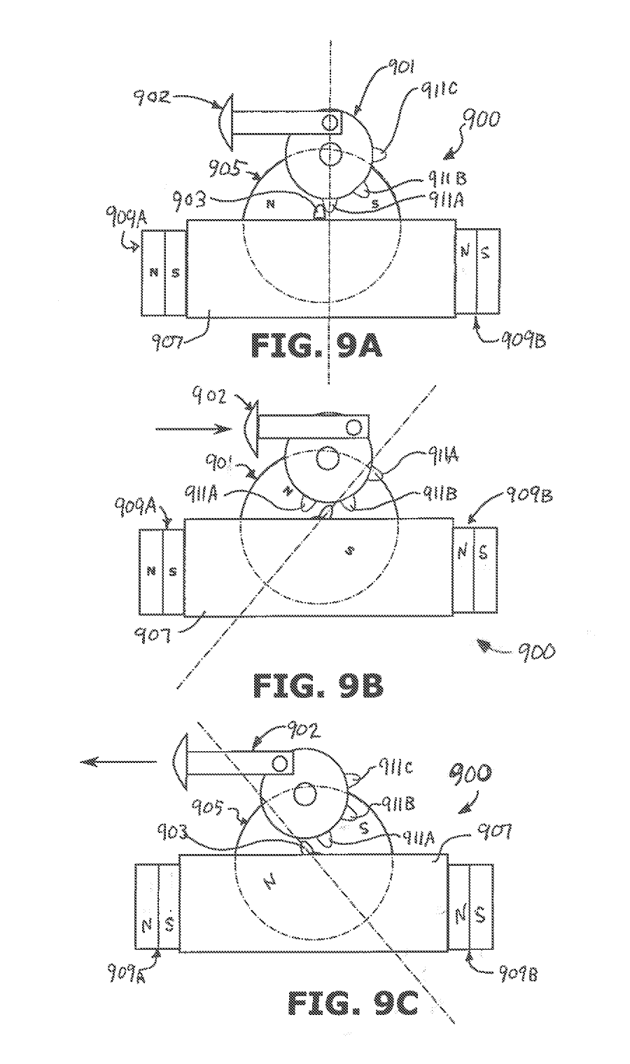

A further embodiment 900 is shown in FIG. 9A that provides a simplified side view of a staggered multi-trigger arrangement having spaced adjacent triggers 911A, 911B, 911C along a surface of an intervening contacting member such as complex plunger rotor 901 that triggers and moves the axially extending tooth 903 of a ball magnet enclosure 905 a plurality of times for each unidirectional (monotonic motion) actuation of the plunger actuator 902 (tangentially attached to the rotor 901 rotatable about a pivot 915) to sequentially engage triggers 911A, 911B, 911C with the tooth 903 to rotate the magnet 905 as taught in the above embodiments, to generate a series of damped sinewaves from the coil 907 surrounding the rotatable magnet 905 that result from the movement action in accordance to Faraday's Law, between engagement of subsequent triggers (e.g. 911B, 911C). This illustration shows a rest position with the magnetic poles of the rotatable magnet 905 aligned with opposite poles of focus magnets 909A, 909B.

The illustration of the embodiment 900 shown in the simplified side elevation view of FIG. 9B shows an initial pushed position of the actuator 902 moving a first tooth 911A striking the radial member 903 to rotate the magnet 905 within the coil 907 as taught above, generate at least one damped sinewave output voltage from the coil 907.

A further position of the actuator 902 and connected member is shown in the simplified elevational illustration FIG. 9C that shows the actuator 902 and connected members positioned on the other side of the initial (resting, quiescent) position that according to the present invention and as taught above, would have generated at least one damped sinewave after striking the radial member 903 in response to a second 911B and third 911C tooth.

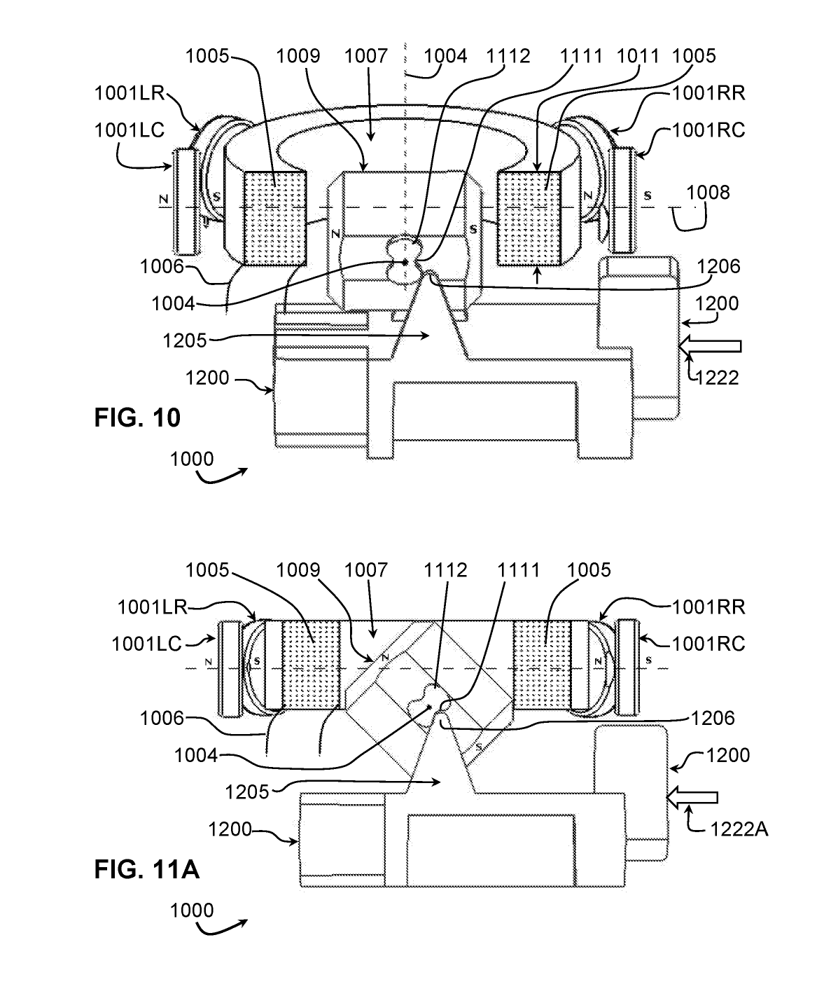

A further embodiment 1000 of the present invention is shown in FIG. 10, comprising a coil 1005 having terminal wires 1006 disposed around an open area 1007 over a width 1011 of the open area substantially bisected by a midline 1008 axis. The embodiment 1000 of FIG. 10 has a section view offset from the midline axis 1008, and also includes groups of focus magnets 1001LC, 1001LR and 1001RR, 1001RC (and other magnets not shown due to the cross-section, analogous to focus magnets of other embodiments described herein), the magnet width (the magnet dimension perpendicular to an axis of N and S poles of each focus magnet) substantially centered on the width 1011 of, and preferably in close proximity to, the coil 1005, and a coil edges at the end of the coil width 1011.

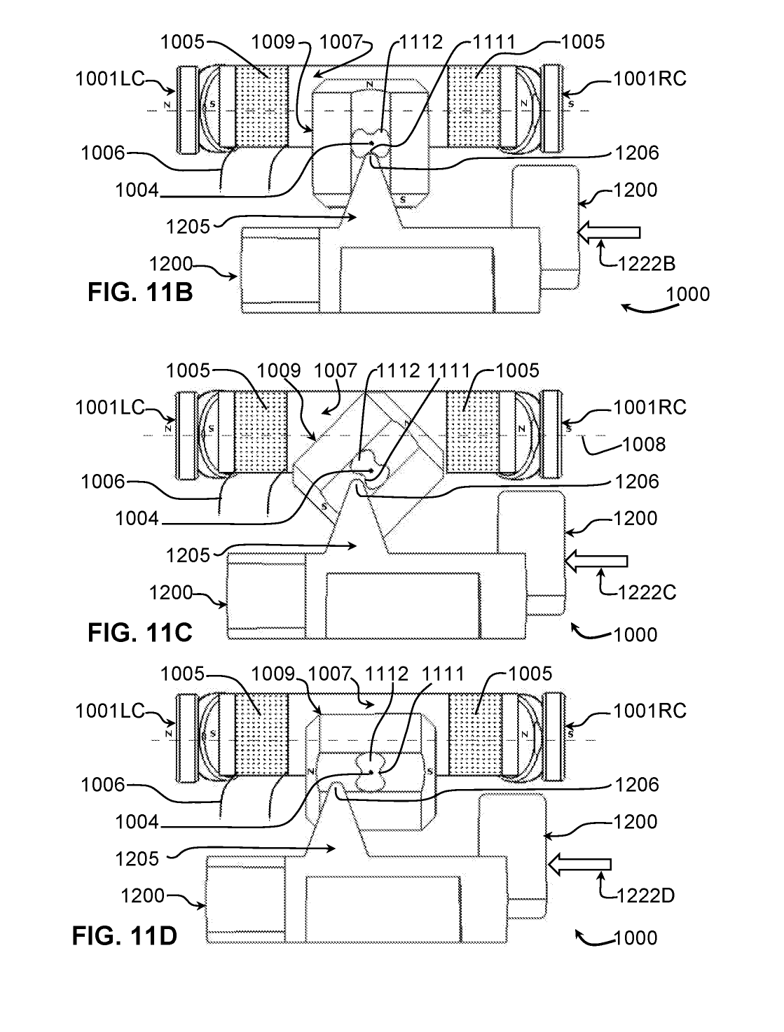

A generally cylindrical magnet 1009 having N and S poles one opposite ends of the cylinder, is received into the open area 1007 and is disposed to rotate on an axis 1004 extending between the N and S poles, preferably offset from the midline axis 1008 and proximal to the edge of the coil 1005 width 1011. A cam 1112 is connected to the magnet 1009 at the axis 1004 includes a recess (i.e. a radial dimension extending from the axis 1004) relative to the adjoining cam 1112 radial surface, which together complement and engage an actuator 1200 mounted member 1205 tip 1206, which is disposed to engage and rotate the cam 1112 (and therefore also the magnet 1009 within the opening 1007 when the actuator 1200 is moved 1222. The FIG. 11A shows the actuator 1200 member 1205 at the beginning of the engagement of the cam 1112, with the magnet 1009 oriented in a quiescent (rest) position having its N and S magnets facing oppositely poled focus magnets. Confronting and engaging surface profiles of cam 1111 and member 1205 other than shown are within the scope of the present invention.

The embodiment of FIG. 10 is shown in FIG. 11A with the actuator 1200 moved by motion 1222A so that the member 1205 further engages the magnet 1009 cam 1112 with the tip 1206 approaching the recess 1111, and the magnet 1009 poles rotated approximately 45 degrees from the prior position.

In FIG. 11B, further motion 1222B is applied causing the actuator 1200 member 1205 tip 1206 to fully enter the cam 1112 recess 1111, in turn causing the magnet 1009 to further rotate on the axis 1004 so that the N and S poles are aligned to be substantially parallel to the coil 1004 width 1011.

As further motion 1222C is applied, the tip 1206 and the cam 1112 recess 1111 begin to separate as shown in FIG. 11C, causing the magnet 1009 to continue to rotate bringing the magnet N and S poles relatively closer to the same S and N polarity poles of the focus magnets (e.g. 1001LC and 1001RC), introducing a repelling force therebetween. As the actuator 1200 is advanced by motion 1222D to its extreme position shown in FIG. 11D, the repulsion between similarly pole magnet 1009 and focus magnets urges the magnet 1009 in close proximity (e.g. FIG. 11C) to thereafter return to the orientation of FIG. 11A, and in the absence of engagement with the member 1205 due to its advancement as shown in FIG. 11D, continues to rotate beyond the position of FIG. 11A, and again return periodically to and move past (or oscillate) the position of FIG. 11A in a decaying cyclical manner until the kinetic energy of the moving magnet 1009 is converted electricity and/or dissipated to mechanical losses.

A molded or bonded coil winding (e.g. by epoxy glue or other self-supporting device or method omitting at least a portion of the bobbin) to which the other disclosed and/or claimed structures relate is considered the equivalent to the disclosed and claimed combination of the bobbin 105 and wire coil thereon for the purpose of this invention. Moreover, embodiments of the rotating magnet 109 and axels 111A, 1118 or their equivalent, without the encapsulation or coverings and including shapes such as cylindrical or otherwise shaped having poles disposed therealong according to the present invention are within the scope of the present invention. Furthermore, also within the scope of the present invention are embodiments having a single focus magnet shaped to surround the coil according to the present invention to replace a plurality of similarly poled focus magnets. These and further embodiments are within the scope of the present invention, which is not to be limited except by the claims which follow.

What is claimed is:

1. An electrical generator, comprising:
a plurality of turns of wire wound substantially around a center hole and at a circumference thereabout and substantially parallel to a plane and having an axis of symmetry extending through said center hole;
a permanent magnet retained in a volume having a center axle extending therefrom and rotatable about said axis of symmetry therethrough, and a surface distal from said center axle,
at least one focus permanent magnet disposed at said circumference of said coil-wire form and are disposed and having magnetic poles aligned perpendicular to said axis of symmetry and stationary relative to said plurality of turns of wire, wherein resultant attraction between said permanent magnet and said focus permanent magnet increases said permanent magnet magnetic flux line density in a region of said plurality of turns of wire and wherein rotation of said permanent magnet about said coil axis of symmetry induces a flow of current in said plurality of turns of wire;
an actuator disposed to be tangentially movable relative to said permanent magnet surface along a direction of motion and disposed to impart a rotational force to said permanent magnet.

2. The electrical generator of claim 1, wherein said permanent magnet includes a tooth member extending radially from said center axle, and said actuator further includes a member extending from said actuator to said tooth disposed to impart a rotational force on said permanent magnet.

3. The electrical generator of claim 2, wherein said actuator includes a plurality of members disposed on and spaced along a surface thereof positioned to sequentially engage said tooth as said actuator is moved.

4. The electrical generator of claim 3, wherein said actuator includes a plurality of elements disposed to translate an applied force to said plurality of actuator.

5. The electrical generator of claim 1, wherein said permanent magnet includes a cam member connected to said center axle and having a radial indentation thereon, and
said actuator further includes a member extending from said actuator to engage said cam and disposed to impart a rotational force on said permanent magnet, and including a member tip formed to be received in said cam radial indentation.

6. The electrical generator of claim 1, wherein said permanent magnet is encapsulated by a non-magnetic covering, wherein said axel extends radially therefrom.

7. The electrical generator of claim 1, wherein said permanent magnet further includes an axle having an axis, and opposing magnetic poles substantially separated by said axle axis.

8. The electrical generator of claim 7, wherein said axle is affixed to and rotatable with said permanent magnet.

9. The electrical generator of claim 1, wherein said actuator further includes a magnet disposed to magnetically engage said permanent magnet and impart a rotational force thereon.

10. The electrical generator of claim 9, wherein said actuator permanent magnet includes a sequence of alternating magnetic poles disposed in alternating sequence along said actuator direction of motion.

11. The electrical generator of claim 10, wherein said permanent magnet includes a portion thereof having a sequence of alternating magnetic poles disposed to magnetically engage said actuator permanent magnet sequence of alternating magnetic poles.

12. The electrical generator of claim 1, further including a plurality of adjacent focus magnets disposed to closely encircle said plurality of turns of wire.

13. The electrical generator of claim 1, wherein said plurality of adjacent focus magnets comprise a first group and a second group of magnets, wherein
each group is substantially radially opposite each other around said plurality of turns of wire, and
said first group includes a plurality of magnets having the same magnetic pole facing said coil of wire, and of a magnetic pole opposite said second group facing magnet pole.

14. A method of electrical generation comprising:
providing a coil of wire having central opening about which said coil of wire is wound;
providing a magnetic core an outer perimeter and having a of North and a South pole disposed along said outer perimeter, wherein said perimeter defines a plane;
engaging said magnetic core North and South poles with a linear motion actuator;
rotating said magnetic core about an axis substantially perpendicular to said magnetic core plane by a force from said linear motion actuator; and
inducing a flow of current through said coil by said rotating said magnetic core.

15. The method of claim 14, wherein said providing a magnetic core comprises providing a magnetic core an outer perimeter and having a plurality of North and a plurality of South poles sequentially disposed along said outer perimeter, wherein said perimeter defines a plane, and said engaging comprises magnetically engaging said plurality of North and said plurality of South poles with a plurality of South and a plurality of North poles disposed on said linear motion actuator.

16. The method of claim 15, wherein at least one of said magnetic core and said linear actuator includes a Poly-magnet.

17. The method of claim 14, wherein said providing a magnetic core comprises a protruding member extending radially outward from an axis extending perpendicular said plane between said magnetic core North and South poles, and said engaging comprises mechanically engaging said magnetic core protruding member with tooth extending from said linear motion actuator.

18. The method of claim 14, further comprising providing a mechanical spring force to said magnetic core by a plurality of focus magnets surrounding said coil of wire.

19. The method of claim 18, further including
providing a constant generation of electricity while said linear motion actuator and magnetic core are engaged, and
providing an oscillatory generation of electricity subsequent to engagement of said linear motion actuator and said magnetic core.

20. The method of claim 18, further including
providing a plurality of rotational forces to said magnetic core with a single, monotonic motion of said linear actuator.
